(19) United States
(12) Patent Application Publication
(10) Pub. No.: US 2013/0075017 A1
(43) Pub. Date: Mar. 28, 2013

(54) METHOD FOR FORMING STRATIFIED RUBBER ARTICLE

(71) Applicants: Christian Jean-Marie Kaes, Schrondweiler (LU); Bruno-Pierre Maitre, Strassen (LU); Gary Robert Burg, Massillon, OH (US); Brian Richard Koch, Hartville, OH (US); Christopher David Dyrlund, Canton, OH (US)

(72) Inventors: Christian Jean-Marie Kaes, Schrondweiler (LU); Bruno-Pierre Maitre, Strassen (LU); Gary Robert Burg, Massillon, OH (US); Brian Richard Koch, Hartville, OH (US); Christopher David Dyrlund, Canton, OH (US)

(21) Appl. No.: 13/590,640

(22) Filed: Aug. 21, 2012

Related U.S. Application Data
(60) Provisional application No. 61/539,690, filed on Sep. 27, 2011.

(51) Int. Cl. B29D 30/06

(52) U.S. Cl. 156/123

(57) ABSTRACT

A method and apparatus for applying a blended rubber composition directly onto a tire building drum or core is described. The method includes the steps of extruding a first rubber compound through a main extruder and a main gear pump. A second rubber compound is extruded through a second extruder and into a second gear pump. The output from the second gear pump is fed into the main extruder. The ratio of the first compound to the second compound is varied by adjusting the speed of the main gear pump and the speed of the second gear pump. A continuous strip of rubber formed of said first compound and said second compound is layed directly onto a tire building machine to form a first layer of rubber having a first blend ratio. The speed of the main gear pump and the second gear pump is adjusted to obtain a second blend ratio of said first compound to said second compound, and then a strip of rubber formed of said second blend ratio is applied to the tire building drum or core.

This application claims the benefits of and incorporates by reference U.S. Provisional Application No. 61/539,690, filed Sep. 27, 2011.

### FIELD OF THE INVENTION

The invention relates in general to tire manufacturing, and more particularly to continuous production of custom rubber mixtures.

### BACKGROUND OF THE INVENTION

Tire manufacturers have progressed to more complicated designs due to an advance in technology as well as a highly competitive industrial environment. In particular, tire designers seek to use multiple rubber compounds in a tire in order to meet customer demands. Using multiple rubber compounds per tire can result in a huge number of compounds needed to be on hand for the various tire lines of the manufacturer. For cost and efficiency reasons, tire manufacturers seek to limit the number of compounds available due to the extensive costs associated with each compound. Each compound typically requires the use of a Banbury mixer, which involves expensive capital expenditures. Furthermore, Banbury mixers have difficulty mixing up tough or stiff rubber compounds. The compounds generated from the Banbury mixers are typically shipped to the tire building plants, thus requiring additional costs for transportation. The shelf life of the compounds is not finite, and if not used within a certain time period, is scrapped.

Thus an improved method and apparatus is desired which substantially reduces the need for the use of Banbury mixers while providing an apparatus and methodology to provide custom mixing at the tire building machine by blending of two or more compounds together, and controlling the ratio of the compounds and other additives. Both non-productive compounds and productive compounds could be blended together. It is further desired to have a system at the tire building machine which provides for the ability to manufacture customizable compounds with accelerators. Yet an additional problem to be solved is to generate the compounds continuously at the tire building machine.

### Definitions

“Aspect Ratio” means the ratio of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Laminate structure” means an unvulcanized structure made of one or more layers of tire or elastomer components such as the innerliner, sidewalls, and optional ply layer.

“Productive compound” means a rubber compound that includes accelerators, sulfur and other materials needed to cure the rubber.

“Non-productive compound” means a rubber compound that does not have one or more of the following items: 1) accelerator; 2) sulfur; or 3) curing agent(s).

### BRIEF DESCRIPTION OF THE DRAWINGS

The invention will be described by way of example and with reference to the accompanying drawings in which:

FIG. 1 is a schematic of a mixing system of the present invention;

FIG. 2 is a schematic showing exemplary output from the mixing system;

FIG. 3 illustrates a cross-sectional profile of a tread of the present invention;

FIG. 4 illustrates a chart of Grosch abrasion Cal. Rate vs. Tan delta at 10% strain (100 deg C., 1 Hz) for output generated from the mixing system;

FIG. 5 is a schematic illustrating a tread profile broken down into grid points; and

FIG. 6 illustrates a continuously stratified tread of the present invention; and

FIG. 7 illustrates a continuously stratified insert of the present invention.

### DETAILED DESCRIPTION OF THE INVENTION

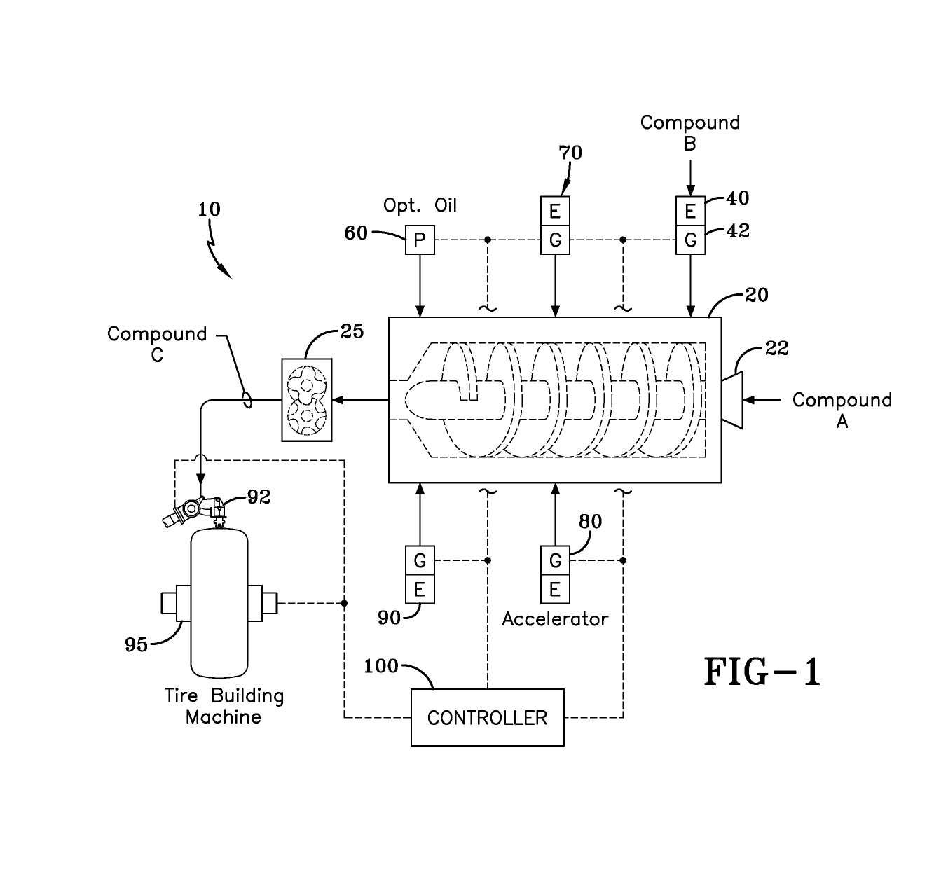

FIG. 1 illustrates a first embodiment of a method and apparatus 10 for a continuous mixing system suitable for use for making rubber compositions for tires or tire components. The continuous mixing system is not limited to tire applications and may be used for example, to make other rubber components not related to tires such as conveyors, hoses, belts, etc. The mixing system may be provided directly at the tire building machinery for direct application of the rubber composition to a tire building drum or other tire building apparatus. in FIG. 1 illustrates a continuous mixing apparatus 10 which includes a main extruder 20. The extruder 20 has an inlet 22 for receiving a first compound A, which may be a productive or non-productive rubber composition. The extruder may comprise any commercial extruder suitable for processing of rubber or elastomer compounds. The extruder may comprise a commercially available extruder commonly known by those skilled in the art as a pin type extruder, a twin screw or a single screw extruder, or a ring type of extruder. One commercially available extruder suitable for use is a multicut transfermix (MCT) extruder, sold by VMI Holland BV, The Netherlands. Preferably, the extruder has an L/D of about 8, but may range from about 5 to about 25, preferably 10-15. A ring type, pin type or MCT type of extruder is preferred, but is not limited to same. The extruder functions to warm up the compound A to the temperature in the range of about 80° C. to about 150° C., preferably about 90° C. to about 120° C., and to masticate the rubber composition as needed.

A second compound, referred to as “compound B” enters the extruder 20 and is mixed with compound A. Compound B may also comprise a productive or non-productive rubber composition. Examples of compound B compositions are described in more detail, below. Compound B is first extruded by second extruder 40 and a second gear pump 42 prior to entering the main extruder 20. Compound B is output from the gear pump 42 into the main extruder in a controlled amount. The second extruder 40 may be a conventional pin type, ring type, dual screw or single screw type extruder. The gear pump 42 functions as a metering device and a pump and may have gears such as planetary gears, bevel gears or other gears. The extruder 40 and gear pump 42 may also be a combination unit. Preferably, compound B enters the main extruder between the entrance 22 and about ⅓ the length of the extruder as measured from the entrance.

The main extruder blends compound A and compound B together in a precisely controlled amount. Oil may be optionally injected into the main extruder 22 via an oil pump 60 at any desired location. The oil controls the viscosity of the compound mixture.

The apparatus 10 may further include a first additive pumping device 70 for pumping one or more additives such as a primary accelerator, which may be optionally added to the mixture at the main extruder 22 or a gear pump 25. The apparatus may further include a second additive pumping device 80 for pumping one or more additives such as a secondary accelerator into the main extruder 22 or the gear pump 25. The apparatus may further include a third additive pumping device 90 for pumping one or more additives such as a third accelerator into the main extruder 22 or the gear pump 25. The additive pumps 70, 80, 90 may be a gear pump, a combination gear pump and extruder, a venturi pump or other pumping means known to those skilled in the art.

If more than one accelerator is used, they may be added into the mixture separately or together. For example, a primary accelerator and a secondary accelerator may both be added. Accelerators are used to control the time and/or temperature required for vulcanization and to improve the properties of the rubber. The accelerator may be in powder form or an encapsulated powder into a resin or rubber base. Examples of accelerator compositions are described in more detail, below.

Other additives include a curative agent or precursor, which may also be added to the extruder 20 via additive pump 90. One example of a curative agent is sulfur. The sulfur may be added in solid form.

The main extruder 22 outputs a rubber mixture which may be a precise mixture of the A and B compound, optional oil and optional accelerants and optional additives, and is referred to as compound C. The output mixture of compound C exits the main extruder 22 and enters a gear pump 25. The gear pump 25 is preferably located adjacent a tire building station 95 for direct application onto a core, tire blank buffed carcass for a retreaded tire or tire building drum, as shown in FIG. 1. Gear pump 25 may preferably comprise a special nozzle or shaping die 92 which applies the compound formulation output from the gear pump 25 directly onto the tire building machine 95 in strips which are wound onto a tire building drum or core.

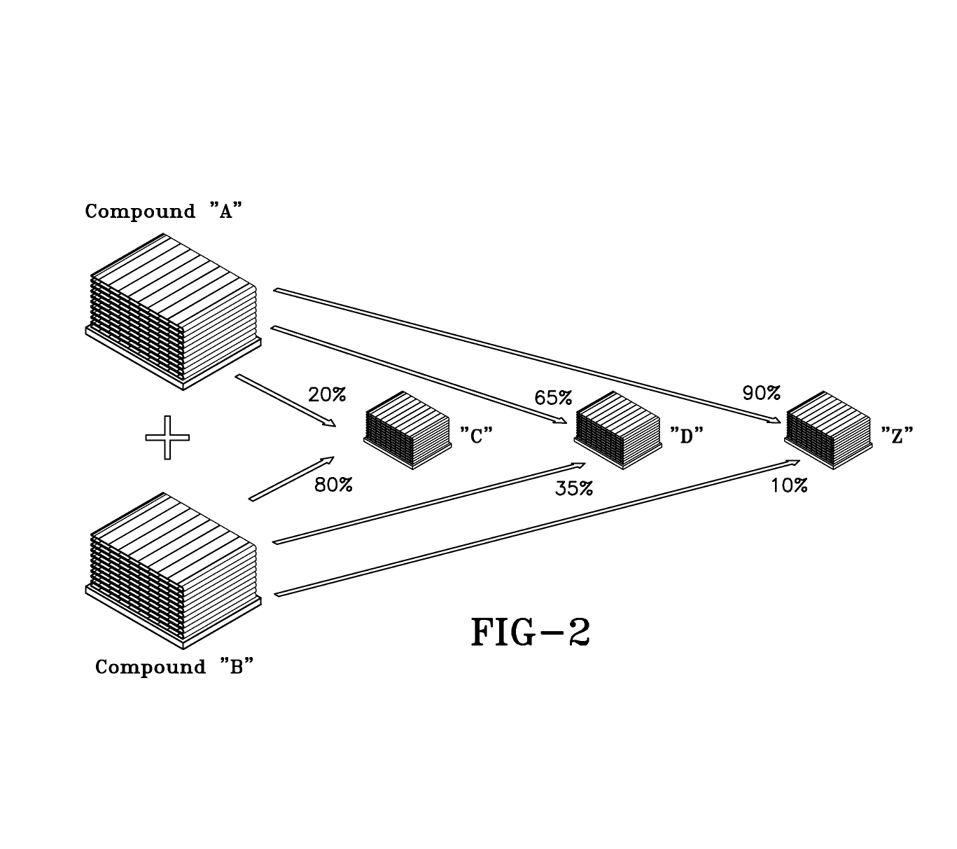

The ratio of the volumetric flow rate of compound A to the volumetric flow rate of compound B is precisely controlled by the ratio of the speed of the gear pump 25 for compound A and the speed of gear pump 42 for compound B. For example, the compound output from the system 10 may comprise a ratio of 20% of compound A and 80% of compound B by volume, as shown in FIG. 2. Alternatively, the compound output from the system may comprise a mixture D having a ratio of 35% of compound B and 65% of compound A by volume. Alternatively, the compound output from the system may comprise a mixture Z having a ratio of 10% of compound B and 90% of compound A by volume. The ratio of compound A to compound B can thus range from 0:100% to 100%:0. The ratio may be adjusted instantaneously by varying the speeds of gear pumps 25 and 42 by a computer controller 100. The computer controller 100 may additionally controls the extruder and gear pump operating parameters such as operating pressure, operating temperature, pump or screw speed.

Preferably, the computer controller 100 sets a pressure target value for the exit pressure of each extruder. The extruder speed is controlled by the controller, and is varied until the pressure target is met. The pressure target value affects the quality of mixing by causing backflow of the material in the extruder.

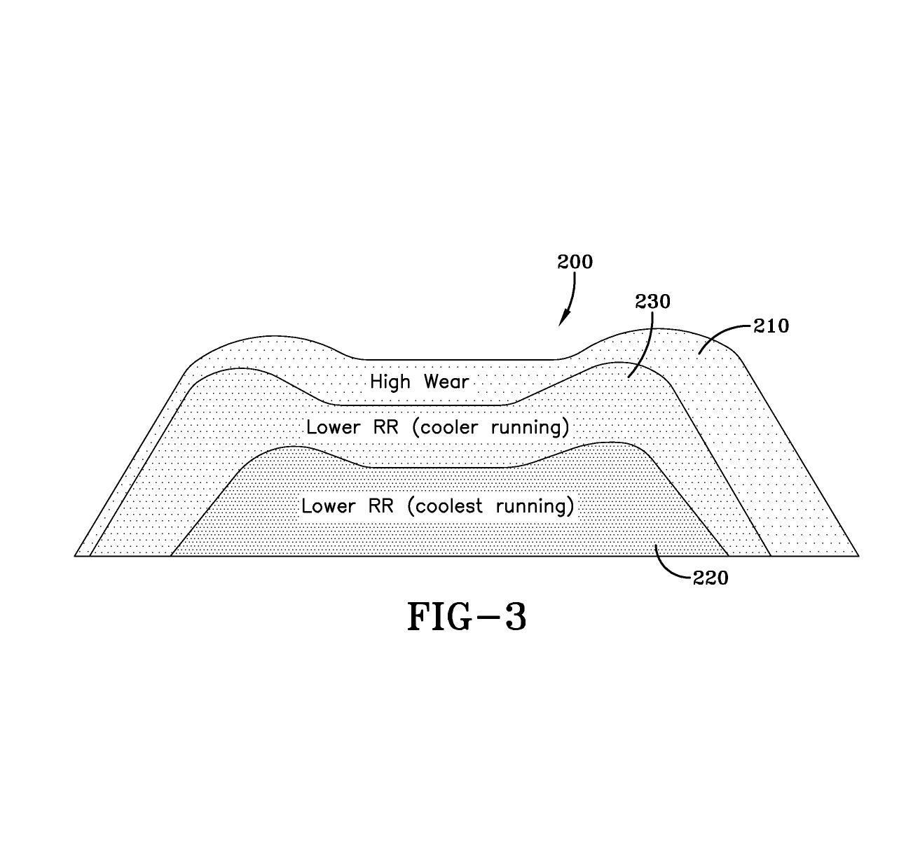

In one example of the invention, a stratified tread 200 is formed having a cross-sectional profile as shown in FIG. 3. The stratified tread is comprised of three or more layers. The radially outermost layer 210 is preferably formed of a tread compound (compound A) that has high wear resistance. High wear resistant tread compounds tend to be stiff compounds, with high fillers. The radially innermost layer 220 is preferably formed of a compound having low or ultra low rolling resistance (compound B). Compounds that have low rolling resistance are generally soft compounds with low fillers. Low rolling resistance compounds tend to have a high wear rate. The middle layer 230 is preferably formed of a blend of the compound selected for the radially outermost layer 210 (compound A) and the radially innermost layer 220 (compound B).

In order to form the tread, a first layer of compound A is extruded onto a form or tire building machine. The tread may be extruded in strips onto the tire building machine. The mixing system of FIG. 1 may be utilized, with the desired compound A selected being fed into the extruder 20. The compound A exits the gear pump 25 and is fed onto tire building drum 95 via nozzle 92. The compound A is extruded onto the tire drum in the desired profile.

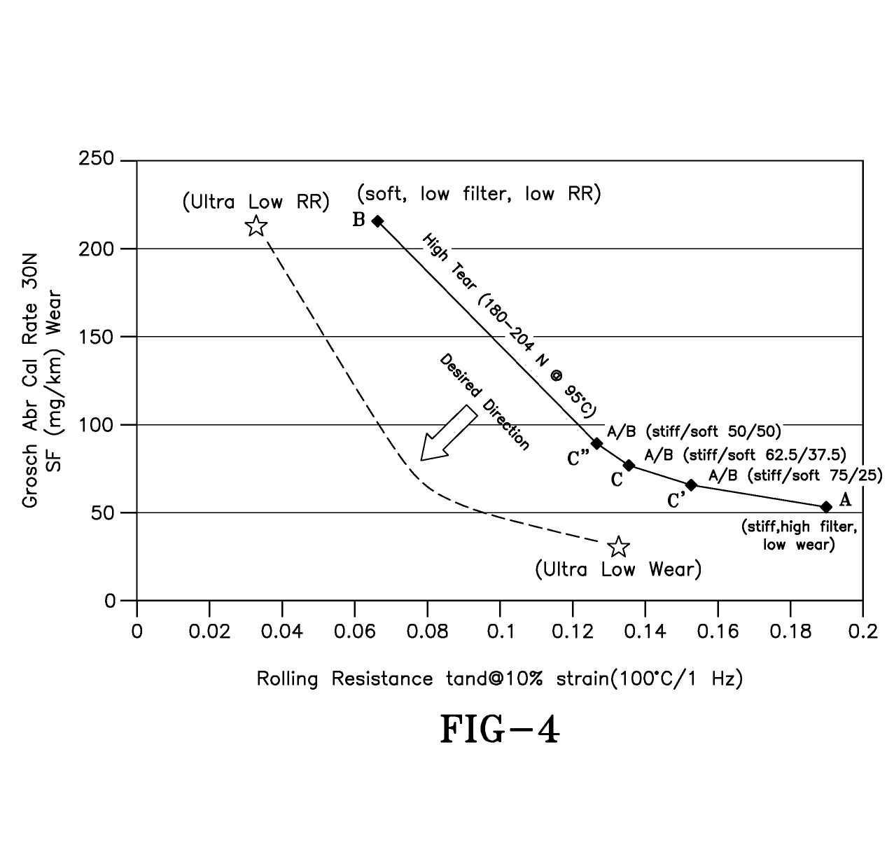

In order to form the middle layer 230, compound A is blended with compound B. Compound B is selected to have low rolling resistance properties. The desired properties of the middle layer dictate the blend ratio of the compounds. For example, as shown in FIG. 4, a 50-50 ratio of Compound A to compound B produces a low rolling resistance compound with low wear resistance (point C). Adjusting the ratio to 75-25 of Compound A to compound B produces a slightly higher rolling resistance compound as compared to C with lowest wear resistance (C″). After the desired blend ratio is selected, the compound A is blended with compound B using a ratio of the gears to get the precise blending. The blend is then extruded onto the tire building drum in the desired profile.

Next, the outer layer if formed by extruding compound B onto the tire building drum over the middle layer in the desired profile. The outer layer may also be a blend of compound A with compound B to arrive at the desired properties.

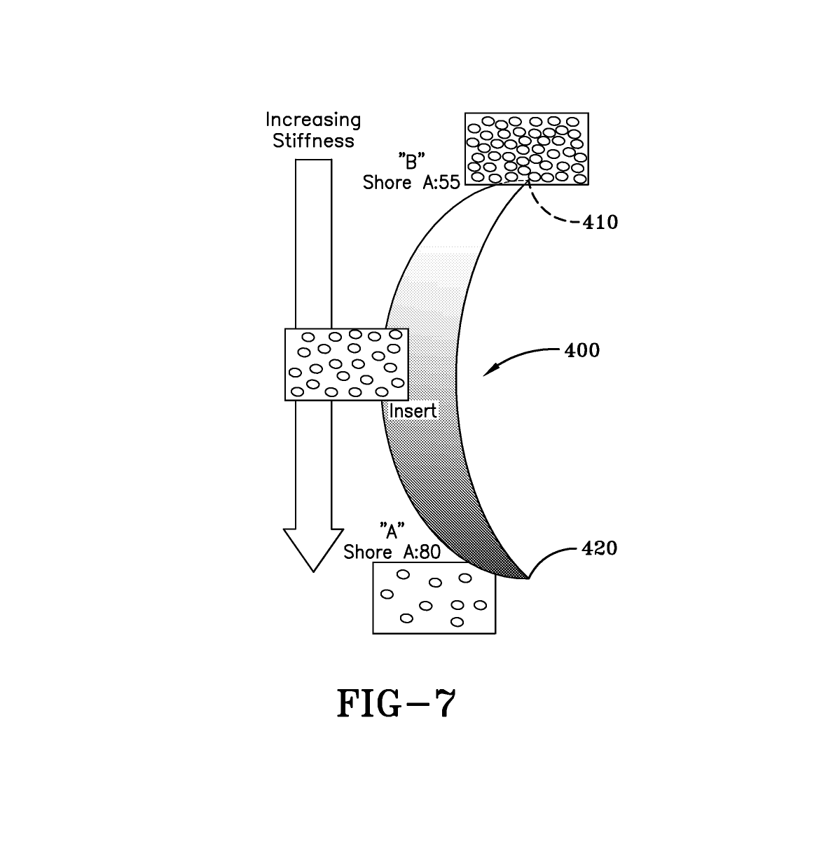

FIG. 6 illustrates a second embodiment of a stratified tread profile 300. The radially outer surface 305 is formed of 100% of compound A. In this example, compound A is selected to have high wear resistance. High wear resistant tread compounds tend to be stiff compounds, with high fillers. The radially innermost layer 310 is formed of compound B. Compound B is selected to have low rolling resistance properties, although other compound properties may be selected.

To form the tread, the mixing system of FIG. 1 may be utilized, with the desired compound A being fed into the extruder 20. The compound A exits the gear pump 25 and is fed onto tire building drum 95 via nozzle 92. The compound A is extruded onto the tire drum in a first layer. A second layer is then extruded over the first layer. The second layer is a blend of compound A and compound B. In one example, the second layer may be formed of 10% compound A with 90% compound B. The mixing system of FIG. 1 is adjusted via speed of gear pumps 25 and 42 so that the output mixture comprises 10% compound A with 90% compound B. A third layer is then extruded over the first layer. The third layer may comprise 20% compound A with 80% compound B. A fourth layer may then be extruded over the third layer, and having a 30-70 ratio. The process may be repeated until the outer layer is formed from 100% compound A.

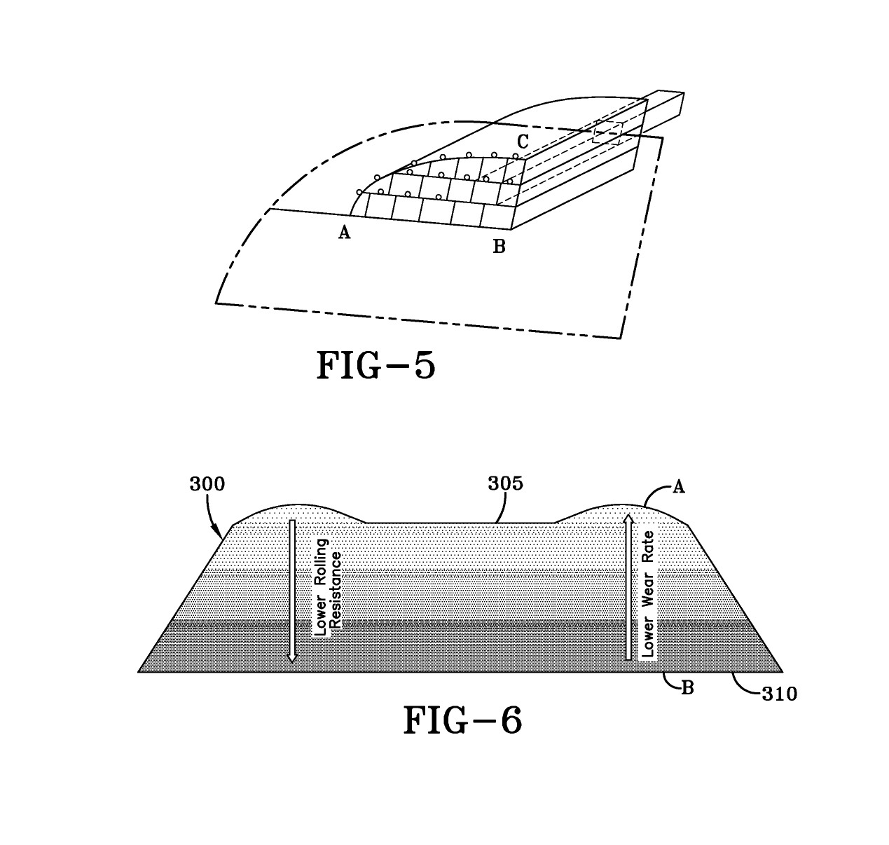

The tread may also be formed by varying the composition or blend ratio of the rubber mixture in the axial direction. The tread may also be formed by varying the composition or blend ratio of the rubber mixture in both the axial and radial direction as desired. FIG. 5 illustrates a portion of the tread profile broken into small increments. Once the ideal tread profile has been designed, the tread profile is broken down into small incremental blocks A, B, C, and the desired blend ratio is selected for each incremental block. Utilizing the computer control, one or more strips having the desired blend ratio may be applied to the tire building drum. The blend ratio may vary in the radial direction, the axial direction, or both directions as desired.

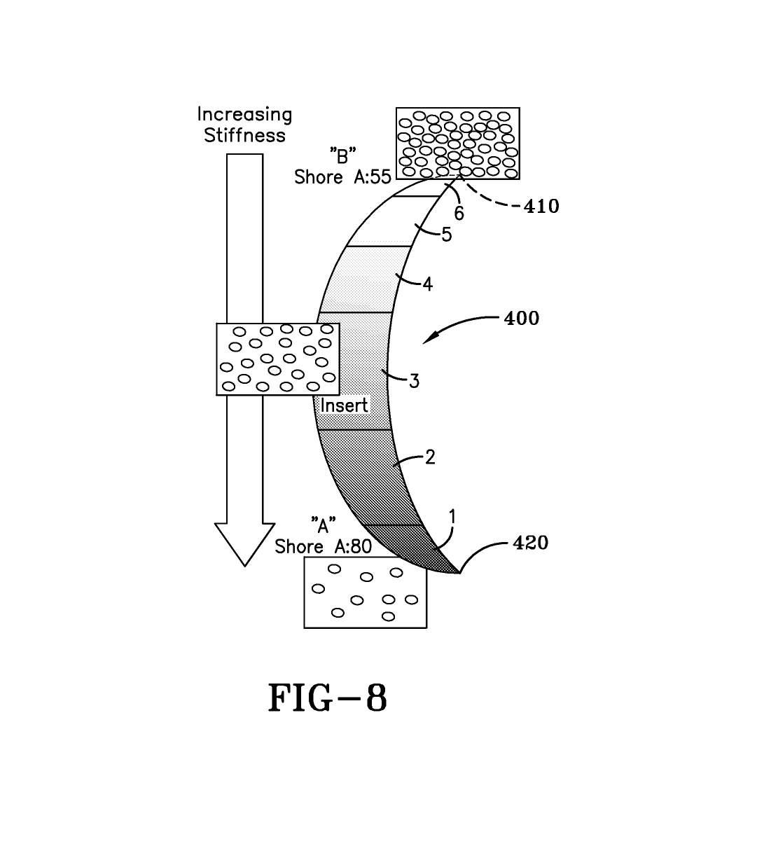

FIG. 7 illustrates a third embodiment of the invention illustrating an insert 400 having a stiffness gradient. The insert component is typically used to make tires having stiffened sidewalls so that the tire does not collapse when the tire loses air. These tires are typically referred to in the industry as run flat or run on flat tires. The insert is typically crescent shaped or lenticular and is typically located in the inner peripheral surface of the sidewall portion of the carcass. The insert of the present invention has a stiffness gradient that varies from a radially outer end 410 to a radially inner end 420. Preferably, the insert has increasing stiffness from the radially outer end to the radially inner end, so that the stiffness of the radially inner end 420 is greater than the stiffness at the radially outer end 410. The radially innermost end 420 is formed of 100% of compound A. Compound A is selected to be made of a very stiff rubber compound, having a Shore A hardness in the range of about 70-90, and more preferably in the range of 75-85. In this example Compound A is selected to be formed of a compound having a shore A hardness of 80. Other desired properties may also be utilized.

The insert at the radially outer end 410 is selected to be formed of a “soft” or flexible compound having a Shore A hardness in the range of 40-60, more preferably in the range of 45-55. At the radially outer end 410, the insert is formed of 100% of a compound “B”.

FIG. 5 illustrates a portion of a tire component profile broken into small blocks or zones. Once the ideal insert profile has been designed, the insert profile is broken down into small incremental zones A, B, C, and the desired blend ratio is selected for each incremental zone. Each zone is formed of one or more annular passes of a strip of rubber having the desired rubber blend. One zone may be smaller than another zone, and may only require one annular revolution of the strip. Other zones may require multiple annular passes of the strip to form the zone. Each zone may have a different size, depending on the material characteristics desired of the insert.

The extruder computer controls system is used to coordinate the extruder compound mixture ratio and the application of the strip onto the tire building drum in accordance with the desired zone compound mixture and number of passes for each zone of the insert profile.

### EXAMPLE 1

To form a first example of an insert of the present invention, the mixing system of FIG. 1 may be utilized, with 100% of the desired compound A being fed into the extruder 20. The compound A exits the gear pump 25 and is fed onto the tire building drum 95 via the nozzle 92 in the sidewall area. The insert is divided into multiple zones, wherein each zone may be formed of compound A, compound B and mixtures thereof. Compound A is extruded in strip form onto the tire drum in a first zone to form the radially innermost end 420 of the insert 400. The first zone is formed of 100% of compound A. Next, a second zone is then extruded over the first zone. The second zone is a blend of compound A and compound B. In one example, the second zone may be formed of 15% compound B with 85% compound A. The mixing system of FIG. 1 is adjusted via speed of gear pumps 25 and 42 so that the output mixture comprises 15% compound B with 85% compound A. A third zone is then extruded over the second zone. The third zone may comprise 30% compound B with 70% compound A. A fourth zone may then be extruded over the third zone, and having a 50% B-50% A ratio. A fifth zone may then be extruded over the fourth zone and have a 60% compound B-40% compound A ratio. A sixth zone may then be extruded over the fixth zone, forming the radially outer end 410 of the insert of 100% compound A. The tire properties of example 1 is shown in Table 1 and further illustrated in FIG. 8. The G′ in table 1 is a cured G′ with a testing temperature of 100C, 10 Hz and a strain of 1% and a cure of 4.9 Min at 191C.

TABLE 1

| | BLEND | | | | | |
|---|---|---|---|---|---|---|
| | RATIO | SHORE | | TAN | HOT | COLD |
| Zone | A/B | A | G′ 1% | DELTA | REBOUND | REBOUND |
| 1 | 100/0 | 82 | 3.65 | .048 | 81 | 75 |
| 2 | 85/15 | 77 | 2.32 | .035 | 84 | 78 |
| 3 | 70/30 | 68 | 1.51 | .024 | 86 | 80 |
| 4 | 50/50 | 62 | 1.12 | .013 | 87 | 80 |
| 5 | 40/60 | 59 | .96 | .009 | 88 | 81 |
| 6 | 0/100 | 46 | .5 | .008 | 88 | 82 |

Unless otherwise noted, all G′ values are measured on an cured (4.9 Min at 191 deg C.) rubber sample temperature of 100 deg C., at a measurement frequency of 10 Hz and at a strain amplitude of 1%. The rubber sample is taken from a cured tire manufactured to the desired manufacturer specifications. For the purposes of this invention, the storage modulus property G′ is a viscoelastic property of a rubber composition and may be determined by a dynamic mechanical analyzer over a range of frequencies, temperature and strain amplitude. One example of a dynamic mechanical analyzer (DMA) suitable for measuring G′, G″ is model number DMA+450 sold by the 01-dB Metravib company. The DMA instrument uses dynamic mechanical analysis to evaluate rubber compositions. A cured sample of the respective rubber composition is subjected to a precisely controlled dynamic excitation (frequency and amplitude) at a frequency (Hertz) and temperature (° C.) and the sample stress response is observed by the instrument. The observed sample response can be separated, by the instrument, into viscous or loss modulus (G″) and elastic or storage modulus (G′) components. Unless otherwise indicated, all G″ are measured at the same conditions as G′.

The following are compositions which may be used in conjunction with the invention.

### I. Accelerator Compositions

In one embodiment, a single accelerator system may be used, i.e., primary accelerator. The primary accelerator(s) may be used in total amounts ranging from about 0.5 to about 4, alternatively about 0.8 to about 1.5, phr. In another embodiment, combinations of a primary and a secondary accelerator might be used with the secondary accelerator being used in smaller amounts, such as from about 0.05 to about 3 phr, in order to activate and to improve the properties of the vulcanized rubber. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. In one embodiment, the primary accelerator is a sulfenamide. If a second accelerator is used, the secondary accelerator may be a guanidine, dithiocarbamate or thiuram compound. Suitable guanidines include dipheynylguanidine and the like. Suitable thiurams include tetramethylthiuram disulfide, tetraethylthiuram disulfide, and tetrabenzylthiuram disulfide.

### II. Rubber Compositions

Representative rubbers that may be used in the rubber compound include acrylonitrile/diene copolymers, natural rubber, halogenated butyl rubber, butyl rubber, cis-1,4-polyisoprene, styrene-butadiene copolymers, cis-1,4-polybutadiene, styrene-isoprene-butadiene terpolymers ethylene-propylene terpolymers, also known as ethylene/propylene/diene monomer (EPDM), and in particular ethylene/propylene/dicyclopentadiene terpolymers. Mixtures of the above rubbers may be used. Each rubber layer may be comprised of the same rubber composition or alternating layers may be of different rubber composition.

The rubber compound may contain a platy filler. Representative examples of platy fillers include talc, clay, mica and mixture thereof. When used, the amount of platy filler ranges from about 25 to 150 parts per 100 parts by weight of rubber (hereinafter referred to as phr). Preferably, the level of platy filler in the rubber compound ranges from about 30 to about 75 phr.

The various rubber compositions may be compounded with conventional rubber compounding ingredients. Conventional ingredients commonly used include carbon black, silica, coupling agents, tackifier resins, processing aids, antioxidants, antiozonants, stearic acid, activators, waxes, oils, sulfur vulcanizing agents and peptizing agents. As known to those skilled in the art, depending on the desired degree of abrasion resistance, and other properties, certain additives mentioned above are commonly used in conventional amounts. Typical additions of carbon black comprise from about 10 to 150 parts by weight of rubber, preferably 50 to 100 phr. Typical amounts of silica range from 10 to 250 parts by weight, preferably 30 to 80 parts by weight and blends of silica and carbon black are also included. Typical amounts of tackifier resins comprise from about 2 to 10 phr. Typical amounts of processing aids comprise 1 to 5 phr. Typical amounts of antioxidants comprise 1 to 10 phr. Typical amounts of antiozonants comprise 1 to 10 phr. Typical amounts of stearic acid comprise 0.50 to about 3 phr. Typical amounts of accelerators comprise 1 to 5 phr. Typical amounts of waxes comprise 1 to 5 phr. Typical amounts of oils comprise 2 to 30 phr. Sulfur vulcanizing agents, such as elemental sulfur, amine disulfides, polymeric polysulfides, sulfur olefin adducts, and mixtures thereof, are used in an amount ranging from about 0.2 to 8 phr. Typical amounts of peptizers comprise from about 0.1 to 1 phr.

### IV. Oil

The rubber composition may also include up to 70 phr of processing oil. Processing oil may be included in the rubber composition as extending oil typically used to extend elastomers. Processing oil may also be included in the rubber composition by addition of the oil directly during rubber compounding. The processing oil used may include both extending oil present in the elastomers, and process oil added during compounding. Suitable process oils include various oils as are known in the art, including aromatic, paraffinic, naphthenic, vegetable oils, and low PCA oils, such as MES, TDAE, SRAE and heavy naphthenic oils. Suitable low PCA oils include those having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom.

Variations in the present inventions are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method of forming an insert for a tire formed from a first compound and a second compound, the insert comprising two or more zones of different mixtures of rubber, the method comprising the steps of:
1) extruding a first rubber compound through a main extruder and a main gear pump;
2) extruding a second rubber compound through a second extruder and a second gear pump into said main extruder;
3) varying the ratio of said first compound to said second compound by adjusting the speed of the main gear pump and the speed of the second gear pump, and then applying a strip of rubber formed of said first compound and said second compound directly onto a tire building machine to form a first zone of rubber having a first blend ratio, wherein the first zone of rubber is extruded in a first desired shape; and
4) adjusting the speed of the main gear pump and the second gear pump to obtain a second blend ratio of said first compound to said second compound, and then applying a strip of rubber formed of said second blend ratio of the first compound to the second compound to form a second zone of rubber having a second blend ratio over said first layer of rubber.

2. The method of claim 1 wherein the insert is divided into at least three zones, wherein a third zone of rubber is formed over the second layer by adjusting the speed of the main gear pump and the speed of the second gear pump to provide a third blend ratio of said first compound to said second compound, and then applying a continuous strip of rubber formed of said third blend ratio of the first compound to the second compound, over said second layer.

3. The method of claim 1 wherein the continuous strip of rubber is applied to the tire building machine using a gear pump in combination with a nozzle.

4. The method of claim 1 wherein the first compound has a Shore A hardness in the range of 70 to about 90.

5. The method of claim 1 wherein the second compound has a Shore A hardness in the range of 45 to about 55.
A method of forming an insert for a tire formed from a first compound and a second compound, the insert comprising two or more zones of different mixtures of rubber, the method comprising the steps of:
1) extruding a first rubber compound through a main extruder and a main gear pump and then applying a strip of rubber formed of said first compound directly onto a tire building machine to form a first zone of the insert and being extruded in a first desired shape;
2) extruding a first rubber compound through a main extruder and a main gear pump and extruding a second rubber compound through a second extruder and a second gear pump into said main extruder;
3) varying the ratio of said first compound to said second compound by adjusting the speed of the main gear pump and the speed of the second gear pump, and then applying a strip of rubber formed of said first compound and said second compound directly onto a tire building machine to form a second zone of the insert having a first blend ratio and being extruded in a desired shape; and
Repeating steps two and three to form additional zones of the insert having a desired blend ratio.
